(19) United States
(12) Patent Application Publication
(10) Pub. No.: US 2025/0200385 A1
(43) Pub. Date: Jun. 19, 2025

(54) METHOD AND APPARATUS FOR PERFORMING RETRAINING OF ARTIFICIAL INTELLIGENCE MODEL IN WIRELESS COMMUNICATION SYSTEM

(71) Applicant: SAMSUNG ELECTRONICS CO., LTD., Suwon-si (KR)

(72) Inventors: Sooeun SONG, Suwon-si (KR); Jungsuk BAIK, Suwon-si (KR); Suhwook KIM, Suwon-si (KR); Wonjun KIM, Suwon-si (KR)

(21) Appl. No.: 18/964,687

(22) Filed: Dec. 2, 2024

(30) Foreign Application Priority Data
Dec. 14, 2023 (KR) 10-2023-0182084

(51) Int. Cl. G06N 3/098

(52) U.S. Cl. CPC G06N 3/098

(57) ABSTRACT

Provided is a 5^{th}-generation (5G) or 6^{th}-generation (6G) communication system for supporting higher data rates after the 4^{th}-generation (4G) communication system such as long term evolution (LTE). A method by which a user equipment (UE) performs communication includes receiving, from a base station (BS), learning model information for an artificial intelligence (AI) model. The method includes determining whether to retrain the AI model, based on inference information obtained by using the AI model and the learning model information. The method includes transmitting, to the BS, a request message for retraining the AI model, in case that the retraining of the AI model is determined.

### CROSS-REFERENCE TO RELATED APPLICATION

This application is based on and claims priority under 35 U.S.C. § 119 to Korean Patent Application No. 10-2023-0182084, filed on Dec. 14, 2023, in the Korean Intellectual Property Office, the disclosure of which is incorporated by reference herein in its entirety.

### BACKGROUND

### 1. Field

Embodiments of the disclosure relate to a method of performing retraining of an artificial intelligence (AI) model in a wireless communication system, and more particularly, to a method of determining and performing retraining of an AI model for federated learning.

### 2. Description of the Related Art

Looking back through successive generations at a process of development of radio communication, technologies for human-targeted services such as voice, multimedia, data, or the like have been developed. Connected devices that are on the explosive rise after commercialization of 5^{th}-generation (5G) communication systems are expected to be connected to communication networks. As examples of things connected to networks, there may be cars, robots, drones, home appliances, displays, smart sensors installed in various infrastructures, construction machinery, factory equipment, etc. Mobile devices are expected to evolve into various form factors such as augmentation reality (AR) glasses, virtual reality (VR) headsets, hologram devices, and the like. In order to provide various services by connecting hundreds of billions of devices and things in the 6^{th}-generation (6G) era, there are ongoing efforts to develop better 6G communication systems. For these reasons, 6G communication systems are referred to as beyond-5G systems.

In the 6G communication system expected to become a reality by around 2030, a maximum transfer rate is tera bits per second (bps), i.e., 1000 giga bps, and a maximum wireless delay is 100 micro seconds (usec). In other words, in the 6G communication system, the transfer rate becomes 50 times faster and the wireless delay is reduced to a one-tenth of the 5G communication system.

To attain these high data transfer rates and ultra-low delay, the 6G communication system is considered to be implemented in the terahertz (THz) band (e.g., ranging from 95 gigahertz (GHz) to 3 THz). Due to the more severe path loss and atmospheric absorption phenomenon in the THz band as compared to the millimeter wave (mmWave) band introduced in 5G systems, importance of technology for securing a signal range, i.e., coverage, is expected to grow. As major technologies for securing coverage, radio frequency (RF) elements, antennas, new waveforms superior to orthogonal frequency division multiplexing (OFDM) in terms of coverage, beamforming and massive multiple-input and multiple-output (massive MIMO), full dimensional MIMO (FFD-MIMO), array antennas, multiple antenna transmission technologies such as large scale antennas, etc., need to be developed. Besides, new technologies for increasing coverage of THz band signals, such as metamaterial based lenses and antennas, a high-dimensional spatial multiplexing technique using orbital angular momentum (OAM), reconfigurable intelligent surface (RIS), etc., are being discussed.

Furthermore, in order to enhance frequency efficiency and system networks, a full duplex technology by which both uplink and downlink transmissions use the same frequency resource at the same time, a network technology that comprehensively uses satellite and high-altitude platform stations (HAPS) and the like, a network structure innovation technology supporting mobile base stations and allowing optimization and automation of network operation, a dynamic spectrum sharing technology through collision avoidance based on spectrum usage prediction, an artificial intelligence (AI) based communication technology to realize system optimization by using AI from the designing stage and internalizing an end-to-end AI supporting function, a next generation distributed computing technology to realize services having complexity beyond the limit of terminal computing capability by using ultrahigh performance communication and computing resources (e.g., mobile edge computing (MEC) cloud) are being developed in the 6G communication system. In addition, by designing new protocols to be used in 6G communication systems, developing mechanisms for implementing a hardware-based security environment and safe use of data, and developing technologies for protecting privacy, attempts to strengthen connectivity between devices, further optimize the network, promote softwarization of network entities, and increase the openness of wireless communication are continuing.

With such research and development of the 6G communication system, it is expected that new levels of the next hyper-connected experience become possible through hyper-connectivity of the 6G communication system including not only connections between things but also connections between humans and things. Specifically, it is predicted that services such as truly immersive extended reality (truly immersive XR), high-fidelity mobile hologram, digital replication, etc., may be provided. Furthermore, services such as remote surgery, industrial automation and emergency response with enhanced security and reliability may be provided through the 6G communication system to be applied in various areas such as industry, medical care, vehicles, appliances, etc.

### SUMMARY

Additional aspects will be set forth in part in the description which follows and, in part, will be apparent from the description, or may be learned by practice of the presented embodiments of the disclosure.

According to an embodiment of the disclosure, a method by which a user equipment (UE) performs communication may include receiving, from a base station (BS), learning model information for an artificial intelligent (AI) model. The method may include determining whether to retrain the AI model, based on inference information obtained by using the AI model and the learning model information. The method may include transmitting, to the BS, a request message for retraining the AI model, in case that the retraining of the AI model is determined.

According to an embodiment of the disclosure, a UE includes a communicator, a memory storing one or more instructions, and at least one processor configured to execute the one or more instructions. The at least one processor may be configured to receive, from a BS, learning model information for an AI model. The at least one processor may be configured to determine whether to retrain the AI model, based on inference information obtained by using the AI model and the learning model information. The at least one processor may be configured to transmit, to the BS, a request message for retraining the AI model, in case that the retraining of the AI model is determined.

According to an embodiment of the disclosure, a method by which a BS performs communication may include transmitting, to a UE, learning model information for an AI model. The method may include receiving a request message for retraining the AI model from the UE. The method may include performing retraining of the AI model based on the request message for relearning. The request message for retraining the AI model may be received from the UE based on inference information obtained by using the AI model and the learning model information.

According to an embodiment of the disclosure, a BS includes a communicator, a memory storing one or more instructions, and at least one processor configured to execute the one or more instructions. The at least one processor may be configured to transmit, to a UE, learning model information for an AI model. The at least one processor may be configured to receive a request message for retraining the AI model from the UE. The at least one processor may be configured to retrain the AI model based on the request message for relearning. The request message for retraining the AI model may be received from the UE based on inference information obtained by using the AI model and the learning model information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a need for retraining an artificial intelligence (AI) model according to an embodiment of the present disclosure;

FIG. 2 illustrates a method of performing retraining of an AI model according to an embodiment of the present disclosure;

FIG. 3 illustrates a flowchart of a method for performing retraining of an AI model according to an embodiment of the present disclosure;

FIG. 4 illustrates an operation of transmitting or receiving learning model information of an AI model according to an embodiment of the present disclosure;

FIG. 5 illustrates an operation of determining whether to retrain an AI model according to an embodiment of the present disclosure;

FIG. 6 illustrates a flowchart of an operation for performing retraining of an AI model according to an embodiment of the present disclosure;

FIG. 7 illustrates an operation of performing retraining of an AI model according to an embodiment of the present disclosure;

FIG. 8 illustrates a method of repeatedly performing retraining of an AI model according to an embodiment of the present disclosure;

FIG. 9 illustrates UE according to an embodiment of the present disclosure; and

FIG. 10 illustrates BS according to an embodiment of the present disclosure.

### DETAILED DESCRIPTION

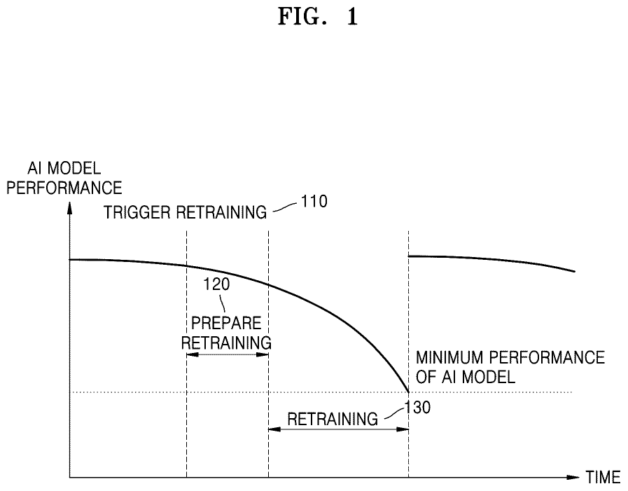

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the disclosure will now be described in detail with reference to accompanying drawings.

Various modifications may be made to embodiments of the disclosure, which will be described more fully hereinafter with reference to the accompanying drawings. The disclosure should be understood as not limited to particular embodiments but including all the modifications, equivalents and replacements which belong to technical scope and ideas of the disclosure.

In the descriptions of embodiments, detailed explanations of the related art are omitted when it is deemed that they may unnecessarily obscure the essence of the disclosure. Ordinal numbers (e.g., first, second, etc.) as used in descriptions of the specification are to distinguish components from one another.

The terms are selected from among common terms widely used at present, taking into account principles of the disclosure, which may however depend on intentions of those of ordinary skill in the art, judicial precedents, emergence of new technologies, and the like. Some terms as herein used are selected at the applicant's discretion, in which case, the terms will be explained later in detail in connection with embodiments of the disclosure. Therefore, the terms should be defined based on their meanings and descriptions throughout the disclosure.

Throughout the disclosure, the expression “at least one of a, b or c” indicates only a, only b, only c, both a and b, both a and c, both b and c, all of a, b, and c, or variations thereof. Throughout the specification, a layer may also be referred to as an entity.

The scope of the disclosure is defined by the appended claims rather than the detailed descriptions. Various features recited in a claim category, e.g., a method claim, of the disclosure may also be claimed in another claim category, e.g., a system claim. Embodiments of the disclosure may include not only a combination of features specified in the appended claims but also various combinations of individual features in the claims. It will be understood by those of ordinary skill in the art that various changes in form and details may be made without departing from the spirit and scope of the disclosure as defined by the appended claims and their equivalents.

Throughout the specification, a component expressed with “ . . . unit,” “ . . . module,” or the like may be a combination of two or more components or may be divided by function into two or more. The function may be implemented in hardware, software, or a combination thereof. Each of the components may perform its major function and further perform part or all of a function served by another component. In this way, part of a major function served by each component may be dedicated and performed by another component.

As used herein, the singular forms “a,” “an” and “the” are intended to include the plural forms as well, unless the context clearly indicates otherwise. All terms including technical and scientific terms used herein have the same meaning as commonly understood by one of ordinary skill in the art to which this disclosure belongs.

Throughout the specification, the expression “or” is inclusive rather than exclusive, unless specifically mentioned otherwise. Hence, unless the context clearly indicates otherwise, “A or B” may refer to “A,” “B” or both. Throughout the disclosure, the expression “at least one of” or “one or more” may indicate different combinations of one or more of items enumerated or may refer to an occasion when an arbitrary one of the items enumerated is required. For example, “at least one of A, B, and C” may include any of the following combinations: A, B, C, A and B, A and C, B and C, or A, B and C.

It will be understood that each block and combination of the blocks of a flowchart may be performed by computer program instructions. The computer program instructions may be loaded onto a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order.

Functions related to AI according to embodiments of the disclosure are operated through a processor and a memory. There may be one or more processors. The one or more processors may include a universal processor such as a central processing unit (CPU), an application processor (AP), a digital signal processor (DSP), etc., a graphic processing unit (GPU), a vision processing unit (VPU), etc., or a dedicated artificial intelligence (AI) processor such as a neural processing unit (NPU). The one or more processors may control processing of input data according to a predefined operation rule or an AI model stored in the memory. When the one or more processors are the dedicated AI processors, they may be designed in a hardware structure that is specific to dealing with a particular AI model.

The predefined operation rule or the AI model may be made by learning. Specifically, a predefined operation rule or an AI model being made by learning refers to the predefined operation rule or the AI model established to perform a desired feature (or an object) being made when a basic AI model is trained by a learning algorithm with a lot of training data. Such learning may be performed by a device itself in which AI is performed according to the disclosure, or by a separate server and/or system. Examples of the learning algorithm may include supervised learning, unsupervised learning, semi-supervised learning, or reinforcement learning, without being limited thereto.

The AI model may include a plurality of neural network layers. Each of the plurality of neural network layers may have a plurality of weight values, and perform neural network operation through operation between an operation result of the previous layer and the plurality of weight values. The plurality of weight values owned by the plurality of neural network layers may be optimized by learning results of the AI model. For example, the plurality of weight values may be updated to reduce or minimize a loss value or a cost value obtained by the AI model during a training procedure. An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, without being limited thereto.

Embodiments of the disclosure will now be described with reference to accompanying drawings to assist those of ordinary skill in the art in readily implementing them. However, the embodiments of the disclosure may be implemented in many different forms, and not limited thereto as will be discussed herein. In the drawings, parts unrelated to the description are omitted for clarity, and like numerals refer to like elements throughout the specification.

Terms as used herein will be described before detailed description of embodiments of the disclosure.

The terms, as will be mentioned later, are defined by taking functionalities in the disclosure into account, but may vary depending on practices or intentions of users or operators. Accordingly, the terms should be defined based on descriptions throughout this specification.

In the disclosure, a user equipment (UE) may include a mobile station (MS), a cellular phone, a smart phone, a computer, a vehicle, a satellite, or a multimedia system capable of performing a communication function.

A base station (BS) as herein used may refer to an entity for performing resource allocation for the UE and may be at least one of gNode B, eNode B, Node B (or, x Node B, where x represents any letter including “g” and “e”), a radio access unit, a BS controller, a satellite, an airborne vehicle or a node in a network, without being limited thereto. In the disclosure, the BS may refer to the BS itself, a cell, or a radio unit (RU) depending on the interpretation, and an entity that exchanges messages with the UE may be a distributed unit (DU) or a central unit (CU) depending on the structure.

In the disclosure, an artificial intelligence (AI) model is a learning model created for a special purpose, and may be referred to as an AI/machine learning (ML) model, an ML model, or a learning model.

The term “training” or “learning” as herein used may refer to updating a model to perform an operation for a special purpose.

The term “machine learning” may refer to a technology to implement a function like human learning ability in a computer.

The term “federated learning” as herein used may refer to a method of training all models based on information of respective UEs in an environment where the respective UEs have the same models.

In the disclosure, the term “learning model information” may refer to information for training the AI model. For example, the learning model information may include configuration information for an AI model itself, information about input data or output data to train the AI model, requirements for training the AI model, etc.

The term “inference” as herein used may refer to an operation of outputting a value resultant from input data to the trained model.

In the disclosure, the term “retraining” or “relearning” may refer to updating a model to perform an operation for a special purpose to secure the performance of the AI model.

In the disclosure, “normalization factor” is a value to be applied to data, and may refer to a constant used in a preprocessing stage where data range is adjusted to standard numerical values.

The term “radio resource control (RRC)” is one of the protocols used between the UE and the BS, which may refer to a radio resource control protocol corresponding to a control plane.

The term “drift” may refer to a phenomenon in which a learning model deteriorates in performance over time.

The term “ground truth” may refer to data of an actual environment used to train and test AI model output values.

The term “updating” may refer to adjusting parameters of an AI model when the AI model is newly trained.

In the disclosure, a position reference unit (PRU) may serve to perform position measurement on the obtained position information.

The term “weight” is a component included in the AI model, and may refer to a value to be applied to input data for inference.

The term “accuracy” as herein used may refer to the proportion of data whose predicted results being the same as actual values among the whole data.

The term “precision” may refer to the proportion of data whose predicted and actual values positively correspond to each other among instances predicted as positive.

The term “recall” may refer to the proportion of data whose predicted and actual values positively correspond to each other among actual positive instances.

The term “fl score” is one of test accuracy metrics, and may refer to a value obtained from precision and recall.

FIG. 1 illustrates a need for retraining an AI model, according to an embodiment of the disclosure.

Referring to FIG. 1, it may be seen that a drift phenomenon occurs where model performance decreases over time. In the disclosure, the AI model may refer to an AI learning model, which will also be referred to as a learning model. As the distribution of data input to the AI model is not always consistent, the performance of the AI model may also be deteriorated depending on the input.

In an embodiment of the disclosure, the AI model may be retrained to overcome the performance deterioration of the AI model due to the occurrence of data drift. Data drift may refer to the statistical distribution of learning input data of the model or the statistical distribution of input data in a real deployment environment differing for various reasons.

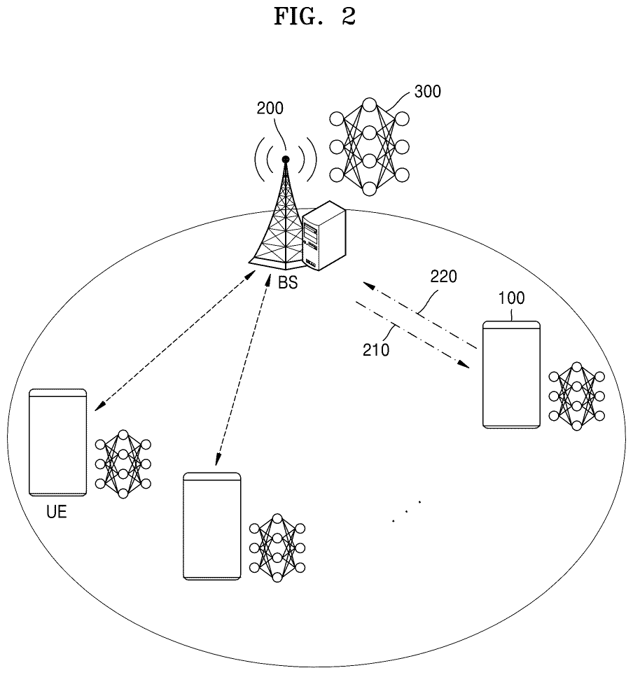

In an embodiment of the disclosure, as the performance of the AI model deteriorates over time, a trigger point (110) for certain retraining may be set. When the performance of the AI model deteriorates to a certain level, i.e., the trigger point (110) for retraining, the BS or the UE may determine whether to retrain the AI model. Whether to retrain the AI model may be determined by the BS or the UE. In an embodiment of the disclosure, the BS may perform retraining at preset intervals. For example, the BS may perform retraining on the AI model when the preset interval is reached. In an embodiment of the disclosure, the UE may determine whether to perform retraining based on information about input data or output data. How the UE determines retraining will be described in detail later with reference to FIG. 2.

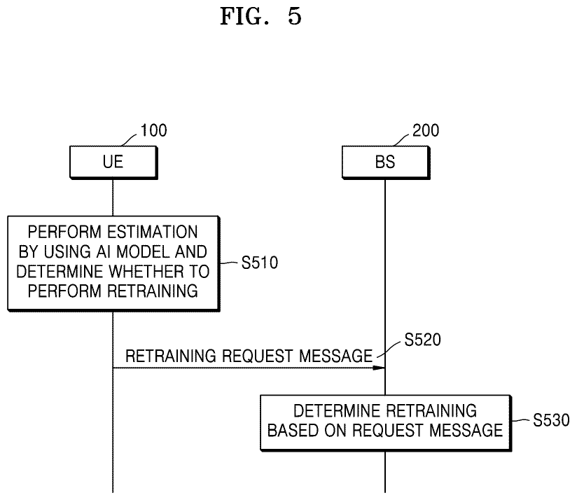

In an embodiment of the disclosure, in case that the UE or the BS determines to retrain the AI model, the UE or the BS may configure retraining configuration information during a retraining preparation period (120). During the retraining preparation period (120), the UE or the BS may set parameters for retraining the AI model or determine e.g., a size of data for retraining. The retraining preparation period (120) will be described in detail later with reference to FIGS. 5 to 7.

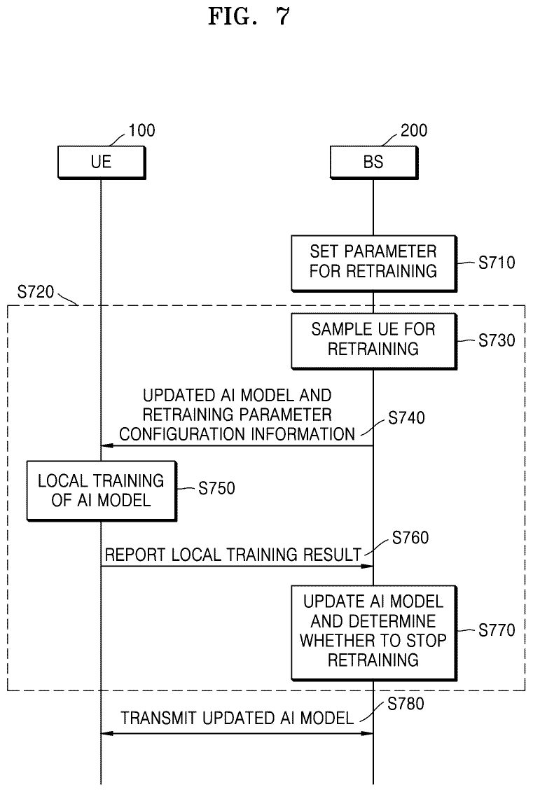

In an embodiment of the disclosure, the UE or the BS may perform retraining (130) on the AI model. The BS or the UE may perform a retraining procedure based on preset retraining configuration information. In the retraining procedure (130), the UE or the BS may repeatedly perform the retraining procedure until satisfying criteria set in the retraining configuration information. The retraining procedure will be described in detail later with reference to FIGS. 7 to 9.

In an embodiment of the disclosure, the AI model may be trained through federated learning. The federated learning may refer to a method of training the whole models based on information of individual UEs in an environment where the UEs have the same models. When the federated learning is performed, the whole models are trained based on the information of the UEs, so the BS does not need to collect a dataset itself. This may secure privacy of the information of the UEs, and as the BS collects only the learning results of the UEs, the BS is able to train the AI model with a small amount of BS memory and train the whole models quickly.

In an embodiment of the disclosure, as the AI model is trained through federated learning, the UE may be a subject of the learning procedure and retraining procedure. In the disclosure, an operation of the UE becoming the subject that determines whether to retrain the AI model will be described in detail.

There is a problem arising when data of each UE is used to train the AI model through the federated learning in the communication system. As the number of ground truth data that the UEs have is small and learning is performed by using estimations, there may be a deviation in error rate in each UE. Furthermore, after the retraining of the AI model is triggered (110), retraining needs to be done before the performance of the AI model drops below the minimum, which is yet restricted because the BS is unaware of the ability or capability of the UE. In an embodiment of the disclosure, the capability of the UE may include the UE's power, memory, memory size, sensor(s), or battery, without being limited thereto.

In an embodiment of the disclosure, with the use of data of the respective UEs, a different amount of data may be obtained from each UE, so the data is non-independent and identically distributed (non-IID). Hence, an AI model biased to a UE from which more data is obtained among the respective UEs may be obtained.

An AI model using federated learning and a method of efficiently performing a retraining procedure will now be described.

FIG. 2 illustrates a method of performing retraining of an AI model according to an embodiment of the present disclosure.

Referring to FIG. 2, a UE 100 and a BS 200 may perform retraining on an AI model 300. The AI model 300 may include a learning model trained by using federated learning. The federated learning may refer to a method of training all models based on information of individual UEs in an environment where the UEs have the same models. The AI model may refer to a model trained through machine learning, and the machine learning may refer to a technology that implements a function like a human learning ability in a computer. In an embodiment, the AI model may include an AI learning model, but is not limited thereto.

When a drift occurs to the federated AI model 300, the UE 100 may determine whether to retrain the AI model to solve the performance deterioration of the AI model. The UE 100 may receive (210), from the BS 200, information for determining whether to perform retraining and information for performing retraining. The UE 100 may transmit (220), to the BS 200, information for performing retraining. The information exchanged between the UE 100 and the BS 200 to perform retraining the AI model will now be described.

In an embodiment of the disclosure, the UE 100 may receive learning model information from the BS 200. The learning model information may include information for AI model deployment, information regarding federated learning, or information for retraining of the AI model, but is not limited thereto. The UE 100 may transmit or receive information for AI model deployment to or from the BS 200. The UE 100 may receive an information message regarding an AI model for AI model deployment from the BS 200. The information message regarding the AI model may include, but not exclusively, characteristics, components, configuration information, requirements, input information or output information of the AI model.

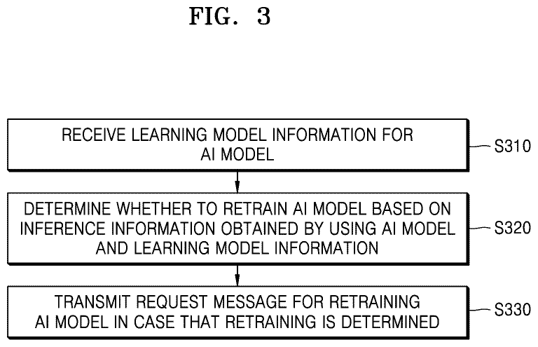

The UE 100 may transmit a message requesting, from the BS 200, an AI model to be used based on input data obtainable by the UE. The UE 100 may receive, from the BS 200, information for retraining and information regarding the AI model to be used based on the request message. The AI model deployment procedure will be described in detail in connection with FIG. 3.

In an embodiment of the disclosure, the UE 100 may determine whether to perform a federated learning based retraining procedure. The UE 100 may obtain inference information based on the AI model 300 from the BS 200. The UE 100 may determine whether to retrain the AI model based on information regarding federated learning and inference information. The information regarding federated learning may include data size information for federated learning, a normalization factor, a tolerance threshold for output data of the AI model, or information regarding the distribution of the learning input data of the AI model. The normalization factor may be obtained based on data of all UEs in the region instead of individual UE. The normalization factor may be obtained through a previous learning procedure. The operation of determining whether to retrain the AI model will be described in detail with reference to FIGS. 3 to 5.

In an embodiment of the disclosure, the UE 100 may perform a retraining procedure for the AI model 300. The UE 100 may transmit, to the BS 200, a message requesting retraining of the AI model 300. In an embodiment of the disclosure, the message requesting retraining may refer to a radio resource control (RRC) message. The UE 100 may receive, from the BS 200, a retraining related information request message. In an embodiment of the disclosure, the retraining related information request message may refer to an RRC message. The retraining related information request message may include, but not exclusively, characteristics information, retraining preparation time or information about a data size for retraining of the AI model for which retraining is determined. The retraining preparation time may refer to a time for which to generate a dataset to be used for retraining. The retraining preparation time may be set regardless of each UE's capability, thereby avoiding a deviation in amount of information obtained between UEs.

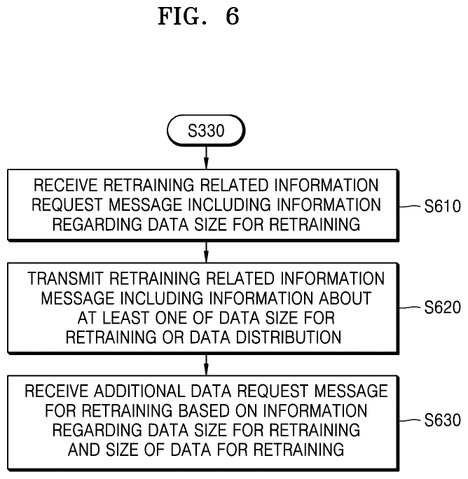

The UE 100 may transmit, to the BS 200, a retraining related information message. In an embodiment of the disclosure, the retraining related information message may refer to an RRC message. The retraining related information message may include, but not exclusively, information regarding a resource available to the UE for the AI model determined to be retrained, information regarding data obtained by the UE, information about a size of a dataset, information about the distribution of input data or information about a ground truth generation method. The UE 100 and the BS 200 may perform a retraining procedure based on messages for the retraining procedure. The retraining procedure will be described in detail later with reference to FIGS. 6 to 8.

In an embodiment of the disclosure, the BS 200 may determine whether additional data is required for retraining based on information about a data size for retraining and a size of data for retraining. When determining that additional data is required, the BS 200 may transmit a message requesting the additional data to the UE 100.

FIG. 3 illustrates a flowchart of a method of performing retraining of an AI model according to an embodiment of the present disclosure.

In operation S310, the UE 100 may receive, from the BS 200, learning model information for an AI model. The learning model information may include an information message regarding the AI model for deployment of the AI model, an AI model message, or information relating to federated learning for the AI model.

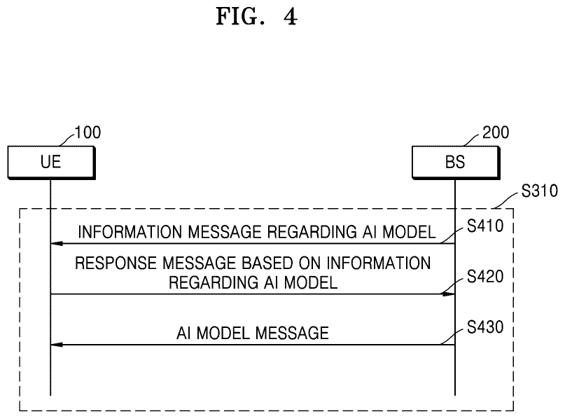

In an embodiment of the disclosure, the information regarding the AI model may include, but not exclusively, characteristics information of the AI model, an identity (ID) of the AI model, configuration information of the AI model, requirements of the AI model, or input and output data information, etc. The information will be described in detail later with reference to FIG. 4.

In an embodiment of the disclosure, the AI model message may include the AI model itself, a structure of the AI model, or an algorithm. The AI model message may include information for retraining the AI model. For example, the AI model message may include information about a tolerance threshold for output data of the AI model or information about the distribution of the learning input data. The learning model information may include a normalization factor used in a preprocessing stage for adjusting a range of data.

In operation S320, the UE 100 may determine whether to retrain the AI model, based on inference information obtained by using the AI model and the learning model information. The UE 100 may obtain output data corresponding to the input data by using the AI model received from the BS 200. The UE 100 may determine whether to retrain the AI model based on information regarding federated learning and inference information included in the learning model information.

In an embodiment of the disclosure, the UE 100 may obtain input data based on the size of a dataset for the AI model to use the AI model. The UE 100 may obtain output data by inputting the obtained input data to the AI model. The input data and output data obtained by the UE 100 may be referred to as inference information.

In an embodiment of the disclosure, the information relating to federated learning may include information about a tolerance threshold for output data of the AI model or information about the distribution of the learning input data. In an embodiment of the disclosure, in case that an error between an output value of the AI model included in the inference information and the ground truth of the UE 100 is at least (greater than or equal to) the tolerance threshold for output data, the UE 100 may determine to perform retraining on the AI model. In an embodiment of the disclosure, based on the information about the distribution of the learning input data, the UE 100 may determine to retrain the AI model in case that the difference between the distribution of the learning input data and the distribution of the obtained input data is at least (greater than or equal to) a preset threshold. For example, when there is data that does not belong to between a minimum value and a maximum value of the learning input data among the obtained input data, or when the distribution of the obtained input data differs from the distribution of the learning input data by the at least (greater than or equal to) preset threshold, the UE 100 may determine to retrain the AI model.

In operation S330, the UE 100 may transmit a request message for retraining the AI model, in case that the retraining of the AI model is determined. In case that the retraining of the AI model is determined to be performed in operation S320, the UE 100 may transmit the request message for retraining the AI model to the BS 200.

In an embodiment of the disclosure, the request message for retraining may include information regarding a reason for requesting the retraining. For example, when the retraining is determined to be performed because a drift occurs to the input data, the retraining request message may include an indicator for indicating that the drift has occurred to the input data. In case that the UE 100 determines to perform retraining based on the tolerance threshold for output data, the retraining request message may include an indicator for indicating that an error between the output data and the ground truth is at least (greater than or equal to) the tolerance threshold.

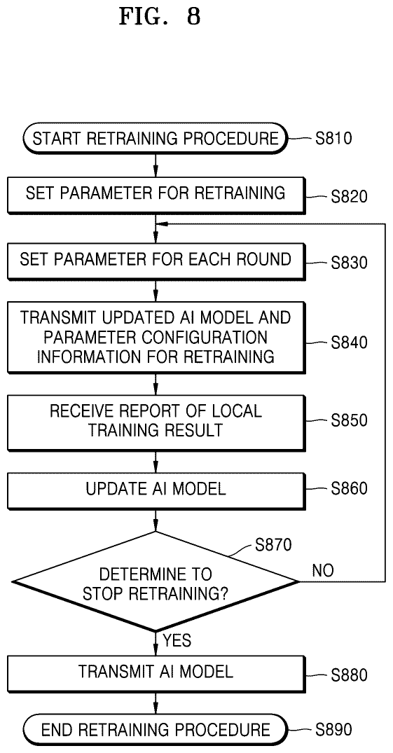

In an embodiment of the disclosure, the UE 100 and the BS 200 may perform a retraining procedure for the AI model based on the request message for retraining the AI model. The retraining procedure will be described in detail later with reference to FIGS. 7 to 8.

FIG. 4 illustrates an operation of transmitting or receiving learning model information of an AI model according to an embodiment of the present disclosure.

Referring to FIG. 4, shown is a detailed operation S310 of FIG. 3 where the UE 100 receives, from the BS 200, learning model information including information relating to federated learning for the AI model. The learning model information may include an information message regarding the AI model for deployment of the AI model and an AI model message. The information included in the information message regarding the AI model and the AI model message will be described in detail later.

In operation S 410, the UE 100 may receive, from the BS 200, the information message regarding the AI model from the BS 200. The UE 100 may receive information regarding the AI model from the BS 200 to perform federated learning. The information regarding the AI model may refer to information about an AI learning model.

In an embodiment of the disclosure, the information regarding the AI model may include characteristics information of the AI model or an ID of the AI model. The characteristics information of the AI model or the ID of the AI model may refer to a purpose of the AI model. For example, when the BS 200 includes a plurality of AI models for positioning or channel estimation, the characteristics information of the AI model or the ID of the AI model may indicate a purpose of each AI model.

In an embodiment of the disclosure, the information regarding the AI model may include configuration information of the AI model. The configuration information of the AI model may include a dimension of input or output, the number of AI model layers, information about parameters, etc. In an embodiment of the disclosure, the information regarding the AI model may refer to requirements of the AI model. The requirements of the AI model may refer to a size of a dataset to be obtained by the UE to use the AI model.

In an embodiment of the disclosure, the information regarding the AI model may include input data information and output data information for the AI model. The input data information may include information regarding the distribution of learning input data. The output data information may include a tolerance threshold for output data of the AI model. Information included in the input data information and output data information may be different depending on the type of the AI model. For example, in a case of an AI model for positioning, the input data information may include downlink (DL) signal received from an RAN, a global navigation satellite system (GNSS), a terrestrial beacon system (TBS), a sensor, etc. The output data information may include an estimated UE position value, a calculated speed value, or a line of sight/non-line of sight (LOS/NLOS) indicator.

In an embodiment of the disclosure, the information regarding the AI model may include a test performance result of the model. The test performance result may include an accuracy, a loss, a standard deviation of the output value of the AI model, etc., without being limited thereto.

In operation S420, the UE 100 may transmit, to the BS 200, a response message based on the information regarding the AI model. The UE 100 may transmit the response message including the information of an AI model to be used by the UE 100 based on the information regarding the AI model received from the BS 200.

In an embodiment of the disclosure, the UE 100 may transmit, to the BS 200, the response message including characteristics information of an AI model to be used by the UE among a plurality of AI models included in the information regarding the AI model or an ID of the AI model. The UE 100 may request, from the BS 200, an AI model configured with obtainable input data information. For example, to perform positioning, the UE 100 may request, from the BS 200, an AI model including a method to be used by the UE among various positioning methods.

In operation S430, the UE 100 may receive, from the BS 200, an AI model message. The BS 200 may transmit, to the UE 100, the AI model requested by the UE 100. In an embodiment of the disclosure, the AI model message may refer to the AI model itself, a structure of the AI model, or an algorithm.

In an embodiment of the disclosure, the AI model message may include information for retraining the AI model. The AI model message may include information about a tolerance threshold for output data of the AI model or the distribution of the learning input data of the AI model. For example, the UE 100 may receive, from the BS 200, the tolerance threshold for output data of the AI model to detect performance deterioration of the AI model due to a model drift. In case that an error between an output value of the AI model and the ground truth of the UE 100 is at least (greater than or equal to) the tolerance threshold, the UE 100 may determine to perform retraining on the AI model.

The UE 100 may receive, from the BS 200, information regarding the distribution of the learning input data of the AI model to detect performance deterioration of the AI model due to the model drift. The information regarding the distribution of the learning input data may include, but not exclusively, average, deviation, maximum value, minimum value, etc., of data used in training the AI model. In an embodiment of the disclosure, the information regarding the distribution of learning input data may be used to determine a normalization factor. Based on the information about the distribution of the learning input data, the UE 100 may determine to retrain the AI model in case that the difference with the obtained input data is at least (greater than or equal to) a preset threshold. For example, when the difference in deviation between the learning input data and the obtained input data is at least (greater than or equal to) the preset threshold or when the obtained input data is not between the minimum value and the maximum value of the learning input data, the UE 200 may determine to retrain the AI model.

In an embodiment of the disclosure, the AI model message may include a normalization factor. The normalization factor is a value to be applied by the UE to the input data during inference using the AI model, and is used in a preprocessing stage to adjust the range of input data obtained by UEs to standard figures. As an inference result is biased when a different normalization factor is applied for each UE, the AI model of the disclosure may apply the normalization factor obtained based on data of the whole UEs in the region through the previous learning may be applied to the input data.

FIG. 5 illustrates an operation of determining whether to retrain an AI model according to an embodiment of the present disclosure.

Referring to FIG. 5, the UE 100 may determine whether to retrain the AI model, based on inference information obtained by using the learning model information and the learning model.

In operation S510, the UE 100 may perform estimation using the AI model and determine whether to perform retraining. The UE 100 may perform estimation based on the AI model received from the BS 200, and determine whether to retrain the AI model by using the obtained inference information. Inference refers to the trained model obtaining an output value based on input data.

In an embodiment of the disclosure, the UE 100 may obtain inference information by using the AI model obtained from the BS 200. The inference information may include input data obtained to be input to the AI model and output data corresponding to the obtained input data. The UE 100 may determine whether to retrain the AI model based on input data and output data included in the inference information.

In an embodiment of the disclosure, the UE 100 may determine whether to retrain the AI model based on information regarding tolerance threshold for output data of the AI model or the distribution of the learning input data included in the information relating to federated learning. In an embodiment of the disclosure, when a drift occurs to the input data obtained by the UE 100, the UE 100 may determine to retrain the AI model. The drift occurring to the input data means that there is a difference between the distribution of the obtained input data and the distribution of the learning input data for various reasons. For example, in case that the difference in deviation between the obtained input data and the learning input data is at least (greater than or equal to) a preset threshold, the UE 100 may determine to retrain the AI model.

In an embodiment of the disclosure, in case that an error between output data obtained by using the AI model and the ground truth of the UE 100 is at least (greater than or equal to) the tolerance threshold for output data, the UE 100 may determine to perform retraining on the AI model. For example, in a case of an AI model for positioning, when position information obtained from a position reference unit (PRU) differs from output data of the AI model, the UE 100 may determine to retrain the AI model. In the case of the AI model for positioning, when a difference between output data and estimated position information is at least (greater than or equal to) the tolerance threshold in the UE that knows the estimated position information, the UE 100 may determine to retrain the AI model.

In operation S520, the UE 100 may transmit, to the BS 200, a retraining request message. In case that the retraining of the AI model is determined to be performed in operation S510, the UE 100 may transmit the message requesting retraining of the AI model to the BS 200.

In an embodiment of the disclosure, the message requesting retraining may include information regarding a reason for requesting the retraining. For example, when the retraining is determined to be performed because a drift occurs to the input data, the retraining request message may include an indicator for indicating that the drift has occurred to the input data. The retraining request message may include a difference in distribution between the obtained input data and the learning input data.

For example, when the UE 100 determines to perform retraining based on the tolerance threshold for output data, the retraining request message may include an indicator for indicating that an error between the output data and the ground truth is at least (greater than or equal to) the tolerance threshold. In an embodiment of the disclosure, the retraining request message may include information about how the UE obtains the ground truth. The retraining request message may include information about an estimated value or the ground truth to be compared with the output data.

In operation S530, the BS 200 may determine retraining based on the request message. On receiving the retraining request message from the UE 100, the BS 200 may determine to retrain the AI model.

In an embodiment of the disclosure, even without receiving the retraining request message from the UE 100, the BS 200 may determine to perform retraining on the AI model at preset retraining intervals. For example, the BS 200 may preset intervals to perform retraining. When the BS 200 receives the retraining request message from the UE 100 or when the retraining interval is reached, the BS 200 may determine to retrain the AI model.

FIG. 6 illustrates a flowchart of an operation of performing retraining of an AI model according to an embodiment of the present disclosure.

Referring to FIG. 6, in operation S330, a retraining procedure for an AI model may be performed based on a request message for retraining the AI model transmitted by the UE 100.

In operation S610, the UE 100 may receive a retraining related request message including information regarding a data size for retraining. The UE 100 may receive the retraining related request message from the BS 200 that determines to perform a retraining procedure based on the retraining request message. In an embodiment of the disclosure, the retraining related request message may refer to an RRC message.

In an embodiment of the disclosure, the retraining request message may include characteristics information or ID of an AI model to be subject to the retraining procedure. The retraining request message may include information regarding a size of data for retraining. The information regarding the size of data for retraining may include information regarding a preparation time for performing the retraining procedure. The preparation time for performing the retraining procedure may refer to a time for which to generate a dataset to be used for retraining. In an embodiment of the disclosure, the information regarding the data size for retraining may include, but not exclusively, information requesting generation of a dataset to be used in retraining, a minimum data size, a maximum data size or information about a recommended data size.

For example, an amount of dataset to be obtained by each UE for a certain period of time may be different. When more data is obtained, it takes long for retraining although there are more data to be used for retraining, and when less data is obtained, it takes short for retraining although there are less data to be used for retraining. The BS 200 may set a size of dataset for the retraining procedure or a preparation time for performing the retraining procedure for which to generate the dataset by taking into account a data obtaining capability that is different for each UE 100. The BS 200 may transmit the configured information to the UE 100.

In an embodiment of the disclosure, the retraining related information request message may include input data information and output data information, but the UE 100 may use the input data information and the output data information included in the learning model information received in operation S310 in the retraining procedure.

In operation S620, the UE 100 may transmit the retraining related information message including at least one of a size of data for the retraining or information regarding a distribution of the data for retraining. Based on the retraining related information request message received in operation S610, the UE 100 may generate a dataset for the retraining procedure and transmit the retraining related message including the information about the generated dataset to the BS 200. In an embodiment of the disclosure, the information message related to retraining may refer to an RRC message.

In an embodiment of the disclosure, the retraining related information message may include resource information of the UE 100 available for the retraining procedure. The retraining related information may include information regarding an input dataset obtained by the UE 100 for the retraining procedure. In an embodiment of the disclosure, the information regarding the input dataset may include an indicator for indicating whether the size of the dataset for the AI model obtained by the UE or a recommended data size is satisfied. The information regarding an input dataset may include information about the distribution of input data included in the input dataset. For example, the information about the distribution of the input data may include information about an average, deviation, maximum value, or minimum value of data, without being limited thereto. In an embodiment of the disclosure, the information regarding the distribution of input data may be used to determine a normalization factor.

In an embodiment of the disclosure, the information regarding an input dataset may include information regarding the ground truth obtained by the UE 100. The information regarding the ground truth may include, but not exclusively, average, deviation, position information, GNSS error rate, etc., of ground truth values obtained by the UE 100. The information regarding the ground truth may include information regarding a non-AI method used by the UE 100 to obtain the ground truth. For example, in a case of the ground truth for positioning, the UE 100 may obtain the ground truth by using GNSS, A-GNSS, sensors, downlink-time difference of arrival (DL-TDOA), etc.

In operation S630, the UE 100 may receive an additional data request message for retraining based on the information about a data size for retraining and a size of data for retraining. The BS 200 may determine whether additional data is required for retraining based on operations S610 and S620.

In an embodiment of the disclosure, when the size of the dataset currently obtained by the UE 100 fails to satisfy the recommended dataset size included in the retraining related information request message, the BS 200 may determine that the obtained data is not sufficient for the retraining procedure. When determining that the obtained data is not sufficient for the retraining procedure, the BS 200 may transmit an additional data request message to the UE 100.

In an embodiment of the disclosure, while some UEs are obtaining extra dataset based on the additional data request message transmitted by the BS 200 to the UEs, the retraining procedure may be performed for UEs that satisfy the recommended dataset size. For example, the size of a dataset obtained by UE A may not meet the recommended dataset size and the size of a dataset obtained by UE B may meet the recommended dataset size. The BS may transmit the additional data request message to UE A. The BS may perform a retraining procedure for an AI model with UE B while UE A is generating an extra dataset. In an embodiment, the BS may postpone the retraining procedure for the AI model with UE B until receiving the extra dataset from UE A. The BS may perform a retraining procedure for both UE A and UE B when receiving the extra dataset from UE A.

In an embodiment of the disclosure, the additional data request message may include information regarding the size of a dataset additionally required or a timer for generating an extra dataset. The information regarding the size of the additionally required dataset may be determined based on information about the size of data for retraining and a data size for retraining. The timer for generating the extra dataset may correspond to a time for generating the extra dataset.

FIG. 7 illustrates an operation of performing retraining of an AI model according to an embodiment of the present disclosure.

Referring to FIG. 7, the operation of performing a retraining procedure for an AI model is described in detail.

In operation S710, the BS 200 may set parameters for retraining. The BS 200 may set parameters related to retraining an AI model.

In an embodiment of the disclosure, the parameters related to retraining may include information regarding a UE to be used for retraining. The parameters related to retraining may include, but not exclusively, a maximum epoch during the retraining, a maximum number of rounds, a maximum epoch for each round, the number of UEs involved in one round, or a size of a dataset included in one round. An epoch refers to the number of times of completing training of the AI model with the whole dataset. The maximum epoch for each round may refer to how many times the learning is repeated with the whole dataset in one round.

In an embodiment of the disclosure, the parameters related to retraining may include a normalization factor. The BS 200 may set the normalization factor obtained through the previous learning to be applied to data for the retraining procedure for the AI model.

In operation S720, the UE 100 and the BS 200 may perform retraining on the AI model based on the parameters for retraining of the AI model. Retraining of the AI model may be performed for several rounds, and one round may be made up of initializing, transmitting of the updated AI model, local training of an AI model in each UE, and updating of the AI model. A method of repeatedly performing the retraining procedure for an AI model will be described later with reference to FIG. 8.

In operation S730, the BS 200 may sample the UE for retraining. Sampling may refer to selecting a defined number of objects for a special purpose from among a plurality of objects. The BS 200 may sample the UE(s) based on the number of UEs set to retrain the AI model.

In an embodiment of the disclosure, the BS 200 may sample the UE for retraining the AI model based on the number of UEs involved in one round. The BS 200 may sample the UE for retraining the AI model for each round.

In operation S740, the BS 200 may transmit the updated AI model and parameter configuration information for retraining to the UE 100. The BS 200 may repeatedly retrain the AI model.

In an embodiment of the disclosure, the BS 200 may transmit, to the UE 100, information regarding the updated AI model with the repetitive retraining of the AI model. The BS 200 may transmit information about the parameters set in operation S710 for retraining to the UE sampled in operation S730.

In an embodiment of the disclosure, the information regarding the updated AI model may include characteristics information of the AI model or an ID of the AI model. The information regarding the updated AI model may include information regarding weights that reflect results obtained until the previous rounds and information regarding a quantization level. The information regarding weights may include, but not exclusively, weight values themselves, changed weight values, indexes corresponding to weights, or a table number corresponding to the weight.

In an embodiment of the disclosure, the parameter information for retraining may include the UE's capability, and a size of a dataset to be used for retraining for each round. The parameter information for retraining may include a normalization factor to be applied to data. The parameter information for retraining may include information required in reporting a retraining result of the AI model. The aforementioned pieces of information are merely an example of the parameter information for retraining, but are not limited thereto.

In operation S750, the UE 100 may perform local training on the AI model. The UE 100 may perform local training for retraining of the AI model based on the obtained input data. In an embodiment of the disclosure, the UE 100 may obtain output data through the updated AI model based on the obtained input data.

In operation S760, the UE 100 may report a result of local training to the BS 200. The UE 100 may report the result of local training for retraining of the AI model to the BS 200.

In an embodiment of the disclosure, the UE 100 may report the weights that reflect the result of each round to the BS 200 according to the quantization level, as a result of local training for retraining. The UE 100 may report the accuracy, precision, recall, fl score, etc., of the AI model derived from a test set performed in the local training for retraining to the BS 200.

In operation S770, the BS 200 may update the AI model and determine whether to stop retraining. The BS 200 may update the AI model and determine whether to stop retraining based on the report of the local training result received in operation S760.

In an embodiment of the disclosure, the BS 200 may update the AI model based on the weights that reflect the result of each round. The BS 200 may determine whether to stop retraining based on the parameter configuration information for retraining. For example, when the maximum number of rounds included in the parameter configuration information is reached, the BS 200 may stop the retraining procedure of the AI model. When the required dataset size included in the parameter configuration information is reached, the BS 200 may stop the retraining procedure of the AI model. In an embodiment of the disclosure, the BS 200 may determine whether to stop retraining based on the report of the local training result. For example, the BS 200 may determine whether to stop retraining based on the accuracy, precision, recall or fl score of the AI model included in the report of the local training result.

In operation S780, the BS 200 may transmit, to the UE 100, the updated AI model. When the retraining procedure is stopped in operation S770, the BS 200 may transmit, to the UE 100, the updated AI model on which retraining results obtained until the corresponding round are reflected.

FIG. 8 illustrates a method of repeatedly retraining an AI model according to an embodiment of the present disclosure.

Referring to FIG. 8, shown is a detailed flowchart of a method by which a BS repeatedly performs retraining of an AI model. For brevity, descriptions overlapping with FIG. 7 will not be repeated.

In operation S810, the BS 200 may start a retraining procedure. The BS 200 may start the retraining procedure for the AI model after the retraining is determined for the AI model.

In an embodiment of the disclosure, the BS 200 may determine whether to retrain the AI model at preset retraining intervals or based on the retraining request message received from the UE 100.

In operation S820, the BS 200 may set parameters for retraining. The BS 200 may set parameters for retraining the AI model. The parameters related to retraining may include information regarding a UE to be used for retraining. The parameters related to retraining may include, but not exclusively, an epoch during the retraining, the maximum number of rounds, a maximum epoch for each round, the number of UEs involved in one round, a size of a dataset included in one round or a normalization factor.

In operation S820, the BS 200 may set parameters for each round. In a case of repeatedly performing the retraining procedure of the AI model, the BS 200 may set parameters for each round.

In an embodiment of the disclosure, the BS 200 may sample UEs involved in the retraining procedure for each round. The BS 200 may sample the UE(s) based on the number of UEs involved in one round set for retraining of the AI model.

In operation S840, the BS 200 may transmit the updated AI model and parameter configuration information for retraining to the UE 100. In an embodiment of the disclosure, the BS 200 may transmit, to the UE 100, information regarding the updated AI model with the repetitive retraining of the AI model.

In an embodiment of the disclosure, the information regarding the updated AI model may include, but not exclusively, characteristics information of the AI model, an ID of the AI model, information regarding weights that reflect results obtained until the previous round, or information regarding a quantization level.

In operation S850, the BS 200 may receive a report of a local training result from the UE 100. The UE 100 may perform local training on the AI model based on the updated AI model and the parameter configuration information for retraining. The UE 100 may transmit the local training result for the AI model to the BS 200.

In an embodiment of the disclosure, the report of the local training result may include information regarding the weights that reflect the result of each round. The report of the local training result may include, but not exclusively, accuracy, precision, recall, fl score, etc., of the AI model derived from a training set performed in the local training.

In operation S860, the BS 200 may update the AI model. The BS 200 may update the AI model based on the report of the local training result received in operation S850.

In operation S870, the BS 200 may determine whether to stop retraining. The BS 200 may determine whether to stop retraining based on the parameter configuration information for retraining or the report of the local training result.

For example, when the maximum number of rounds included in the parameter configuration information is reached or when the required dataset size included in the parameter configuration information is reached, the BS 200 may stop the retraining procedure for the AI model. The BS 200 may determine whether to stop retraining based on the accuracy, precision, recall or fl score of the AI model included in the report of the local training result.

In an embodiment of the disclosure, when determining to stop the retraining procedure for the AI model, the BS 200 may transmit the updated AI model to the UE 100 in operation S880. In an embodiment of the disclosure, when determining not to stop the retraining procedure for the AI model, the BS 200 may go back to operation S830 to perform the retraining procedure of the next round.

In operation S890, the UE 100 and the BS 200 may stop the retraining procedure. In an embodiment of the disclosure, in case that it is determined that the AI model obtained through the retraining procedure requires the retraining procedure, the UE 100 and the BS 200 may resume the retraining procedure.

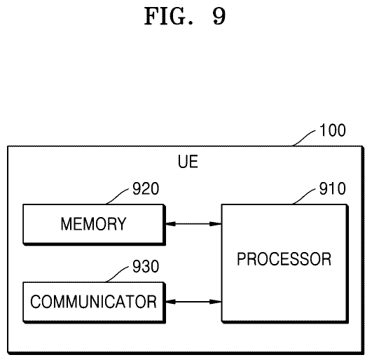

FIG. 9 illustrates a UE according to an embodiment of the present disclosure.

Referring to FIG. 9, the UE 100 may include at least one processor 910 for executing at least one instruction, a memory 920 for storing the at least one instruction and a communicator 930 for communicating with an external device (e.g., another UE, a BS, etc.). However, not all the components as shown herein are essential, and the UE 100 may be implemented with more or fewer components than the components as shown herein.

The processor 910 controls general operation of the UE 100. For example, the processor 910 may perform a function of the UE 100 as described in the disclosure by executing one or more instructions stored in the memory 920. In this case, the memory 920 may store the one or more instructions to be executed by the processor 910. Furthermore, the processor 910 may have a built-in memory that stores one or more instructions and execute the one or more instructions stored in the built-in memory to perform the aforementioned operations. In other words, the processor 910 may execute at least one instruction or program stored in the built-in memory equipped in the processor 910 or the memory 920 to perform a certain operation.

The processor 910 may include one or more processors. The one or more processors may include a universal processor such as a central processing unit (CPU), an application processor (AP), a digital signal processor (DSP), etc., a dedicated graphic processor such as a graphic processing unit (GPU), a vision processing unit (VPU), etc., or a dedicated artificial intelligence (AI) processor such as a neural processing unit (NPU). When the one or more processors are the dedicated AI processors, they may be designed in a hardware structure that is specific to dealing with a particular AI model.

In an embodiment of the disclosure, the processor 910 may infer output data corresponding to input data through the AI model. The processor 910 may determine whether to retrain the AI model based on information regarding federated learning and inference information included in the learning model information received through the communicator 930. The processor 910 may determine whether to retrain the AI model based on information regarding a tolerance threshold for output data of the AI model or information regarding the distribution of learning input data of the AI model.

In an embodiment of the disclosure, in case that an error between output data included in the inference information and the ground truth obtained by the UE 100 is at least (greater than or equal to) the tolerance threshold, the processor 910 may determine to perform retraining on the AI model. In an embodiment of the disclosure, based on the information about the distribution of the learning input data of the AI model, the processor 910 may determine to retrain the AI model in case that an error between input data included in the inference information and the learning input data is at least (greater than or equal to) a preset threshold.

In an embodiment of the disclosure, in case that the AI model is determined to be retrained, the processor 910 may perform a retraining procedure. The processor 910 may determine to retrain the AI model based on a request message related to retraining received and information message related to retraining transmitted through the communicator 930. In an embodiment of the disclosure, the processor 910 may generate a dataset for retraining based on the information regarding the data size for retraining.

The memory 920 may store a program for processing and control of the processor 910, or store data input to or output from the UE 100. The memory 920 may include at least one type of storage medium including a flash memory, a hard disk, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable ROM (PROM), a magnetic memory, a magnetic disk, and an optical disk.

In an embodiment of the disclosure, the memory 920 may store information relating to federated learning included in the learning model information received from the BS 200 through the communicator 930. The memory 920 may store input data information for the AI model. The memory 920 may store output data information obtained through the AI model.

The communicator 930 may include one or more modules that enable wireless communication between the UE 100 and the BS 200 or a network where another UE is located. The communicator 930 may transmit or receive data or signals to or from the BS 200 or a UE over a wired or wireless network. In an embodiment of the disclosure, the communicator 930 includes at least one communication module such as a short-range communication module, a wired communication module, a mobile communication module, a broadcast receiving module, etc. The at least one communication module refers to a communication module that may perform data transmission and reception over a network that conforms to a communication protocol such as a tuner for performing broadcast reception, Bluetooth, wireless LAN (Wi-Fi), Wibro, Wimax, code division multiple access (CDMA), wideband CDMA (WCDMA).

For example, the communicator 930 may include a wireless fidelity ((Wi-Fi) module, a Bluetooth module, an infrared communication module, a wireless communication module, a local area network (LAN) module, an Ethernet module, a wired communication module, etc. In this case, each communication module may be implemented in the form of at least one hardware chip. The Wi-Fi module and the Bluetooth module perform communication in a Wi-Fi scheme and a Bluetooth scheme, respectively. In the case of using the Wi-Fi module or the Bluetooth module, it may first transmit or receive various connection information such as a service set identifier (SSID) and a session key, use this to establish communication, and then transmit and receive various information. The wireless communication module may include at least one communication chip for performing communication according to various wireless communication standards such as zigbee, third generation (3G), third generation partnership project (3GPP), long term evolution (LTE), LTE advanced (LTE-A), fourth generation (4G), fifth generation (5G), etc. The communicator 930 may include a communication circuit for performing communication such as Bluetooth with an electronic device and an interface circuit connected to an external device.

In an embodiment of the disclosure, the communicator 930 may receive information message about an AI model from the BS 200 for deployment of the AI model, and transmit a response message to the BS 200 based on information regarding the AI model. The communicator 930 may receive an AI model to be used by the UE 100 from the BS 200. The communicator 930 may receive, from the BS 200, learning model information including information relating to federated learning for the AI model. The communicator 930 may transmit, to the BS 200, a request message about retraining to perform a retraining procedure.

In an embodiment of the disclosure, the communicator 930 may receive, from the BS 200, a retraining related Information request message including information regarding a data size for retraining. The communicator 930 may transmit, to the BS 200, the retraining related information message including at least one of a size of data for the retraining or information regarding the data distribution for retraining.

Detailed information included in the message was described above in connection with FIGS. 2 to 8.

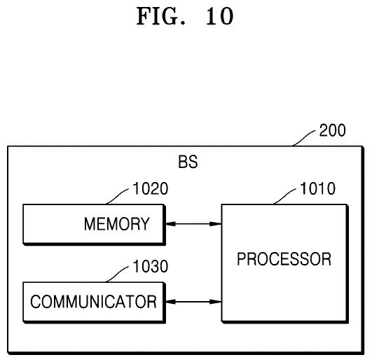

FIG. 10 illustrates a BS according to an embodiment of the present disclosure.

Referring to FIG. 10, the BS 200 may include at least one processor 1010 for executing at least one instruction, a memory 1020 for storing the at least one instruction and a communicator 1030 for communicating with an external device (e.g., a UE, another BS, etc.). However, not all the components as shown herein are essential, and the BS 200 may be implemented with more or fewer components than the components as shown herein.

The processor 1010 controls general operation of the BS 200. For example, the processor 1010 may perform a function of the BS 200 as described in the disclosure by executing one or more instructions stored in the memory 1020. In this case, the memory 1020 may store the one or more instructions to be executed by the processor 1010. Furthermore, the processor 1010 may have a built-in memory that stores one or more instructions and execute the one or more instructions stored in the built-in memory to perform the aforementioned operations. In other words, the processor 1010 may execute at least one instruction or program stored in the built-in memory equipped in the processor 1010 or the memory 1020 to perform a certain operation.

The processor 1010 may include one or more processors. The one or more processors may include a universal processor such as a CPU, an AP, a DSP, etc., a dedicated graphic processor such as a GPU, a VPU, etc., or a dedicated AI processor such as an NPU. When the one or more processors are the dedicated AI processors, they may be designed in a hardware structure that is specific to dealing with a particular AI model.

In an embodiment of the disclosure, the processor 1010 may determine to retrain an AI model when receiving a message requesting retraining of the AI model from the UE 100 through the communicator 1030 or when a preset interval for retraining is reached.

In an embodiment of the disclosure, the processor 1010 may set parameters for retraining the AI model. The processor 1010 may sample a UE for retraining a learning model. The processor 1010 may update the AI model by reflecting a retraining result of the AI model and determine whether to stop retraining. In an embodiment of the disclosure, the processor 1010 may determine whether an additional dataset is required when it is determined that the size of data for retraining received from the UE 100 is not sufficient for the retraining procedure.

The memory 1020 may store a program for processing and control of the processor 1010, or store data input to or output from the BS 200. The memory 1020 may include at least one type of storage medium including a flash memory, a hard disk, a multimedia card micro type memory, a card type memory (e.g., SD or XD memory), a RAM, an SRAM, a ROM, an EEPROM, a PROM, a magnetic memory, a magnetic disk, and an optical disk.

In an embodiment of the disclosure, the memory 1020 may store information regarding at least one AI model. The memory 1020 may store an indicator for indicating whether retraining of the AI model is required or a reason for requiring the retraining, based on the retraining request message received from the UE 100. In an embodiment of the disclosure, the memory 1020 may store information regarding a set interval for retraining the AI model.

In an embodiment of the disclosure, the memory 1020 may store parameter configuration information set for retraining the AI model. The memory 1020 may store information and parameters regarding an updated AI model for each round of the retraining.

The communicator 1030 may include one or more modules that enable wireless communication between the BS 200 and a network where the UE 100 is located. The communicator 1030 may transmit or receive data or signals to or from the UE 100 over a wired or wireless network. In an embodiment of the disclosure, the communicator 1030 includes at least one communication module such as a short-range communication module, a wired communication module, a mobile communication module, a broadcast receiving module, etc. The at least one communication module refers to a communication module that may perform data transmission and reception over a network that conforms to a communication protocol such as a tuner for performing broadcast reception, Bluetooth, wireless LAN (Wi-Fi), Wibro, Wimax, CDMA, WCDMA.

For example, the communicator 1030 may include a Wi-Fi module, a Bluetooth module, an infrared communication module, a wireless communication module, a LAN module, an Ethernet module, a wired communication module, etc. In this case, each communication module may be implemented in the form of at least one hardware chip. The Wi-Fi module and the Bluetooth module perform communication in a Wi-Fi scheme and a Bluetooth scheme, respectively. In the case of using the Wi-Fi module or the Bluetooth module, it may first transmit or receive various connection information such as a service set identifier (SSID) and a session key, use this to establish communication, and then transmit and receive various information. The wireless communication module may include at least one communication chip for performing communication according to various wireless communication standards such as zigbee, 3G, 3GPP, LTE, LTE-A, 4G, 5G, etc. The communicator 1030 may include a communication circuit for performing communication such as Bluetooth with an electronic device and an interface circuit connected to an external device.

In an embodiment of the disclosure, the communicator 1030 may transmit, to the UE 100, learning model information including information relating to federated learning for the AI model. The communicator 1030 may transmit information message about an AI model and the AI model to the UE 100.

In an embodiment of the disclosure, the communicator 1030 may receive a message requesting retraining of the AI model from the UE 100. The communicator 1030 may transmit a message requesting retraining related information to the UE 100 as the processor 1010 determines to retrain the AI model. The communicator 1030 may receive a retraining related information message.

In an embodiment of the disclosure, the communicator 1030 may transmit, to the UE 100, parameters set for retraining the AI model and an AI model updated for each round of the retraining. The communicator 1030 may receive a report for a local training result from the UE 100. The communicator 1030 may transmit an updated AI model to the UE 100 as the retraining procedure for the AI model is completed.

The machine-readable storage medium may be provided in the form of a non-transitory storage medium. The term “non-transitory storage medium” may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

According to an embodiment of the disclosure, a method by which a UE performs communication may include receiving, from a BS, learning model information for an AI model. The method may include determining whether to retrain the AI model, based on inference information obtained by using the AI model and the learning model information. The method may include transmitting, to the BS, a request message for retraining the AI model, in case that the retraining of the AI model is determined.

In an embodiment of the disclosure, the learning model information may include information about a data size for federated learning.

In an embodiment of the disclosure, the learning model information may include information about a tolerance threshold based on learning output data of the AI model or information about a distribution of learning input data of the AI model.

In an embodiment of the disclosure, the method may include determining to retrain the AI model in case that an error between the leaning output data and output data included in inference information is at least (greater than or equal to) the tolerance threshold.

In an embodiment of the disclosure, the method may include, based on the information about the distribution of the learning input data of the AI model, determining to retrain the AI model in case that an error between input data included in the inference information and the learning input data is at least (greater than or equal to) a preset threshold.

In an embodiment of the disclosure, the learning model information may include a normalization factor about data for training the AI model.

In an embodiment of the disclosure, the method may include performing retraining of the AI model based on a request message for retraining.

In an embodiment of the disclosure, the method may include receiving, from the BS, a retraining related Information request message including information regarding a data size for retraining. The method may include transmitting, to the BS, the retraining related information message including at least one of a size of data for the retraining or information regarding a distribution of the data for retraining.

In an embodiment of the disclosure, the method may include receiving, from the BS, a message requesting additional data for retraining based on the information about the data size for retraining and the size of data for retraining.

According to an embodiment of the disclosure, a UE for performing communication includes a communicator, a memory storing one or more instructions, and at least one processor configured to execute the one or more instructions. The at least one processor may be configured to receive, from a BS, learning model information for an AI model. The at least one processor may be configured to determine whether to retrain the AI model, based on inference information obtained by using the AI model and the learning model information. The at least one processor may be configured to transmit, to the BS, a request message for retraining the AI model, in case that the retraining of the AI model is determined.

According to an embodiment of the disclosure, a method by which a BS performs communication may include transmitting, to a UE, learning model information for an AI model. The method may include receiving a request message for retraining the AI model from the UE. The method may include performing retraining of the AI model based on the request message for retraining. The request message for retraining the AI model may be received from the UE based on inference information obtained by using the AI model and the learning model information.

According to an embodiment of the disclosure, a BS for performing communication includes a communicator, a memory storing one or more instructions, and at least one processor configured to execute the one or more instructions. The at least one processor may be configured to transmit, to a UE, learning model information for an AI model. The at least one processor may be configured to receive a request message for retraining the AI model from the UE. The at least one processor may be configured to perform retraining of the AI model based on the request message for retraining. The request message for retraining the AI model may be received from the UE based on inference information obtained by using the AI model and the learning model information.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE), the method comprising:
receiving, from a base station (BS), learning model information for an artificial intelligence (AI) model;
determining whether to retrain the AI model based on inference information obtained by using the AI model and the learning model information; and
transmitting, to the BS, a request message for retraining the AI model in case that retraining of the AI model is determined.

2. The method of claim 1, wherein the learning model information comprises information associated with a data size for training the AI model.

3. The method of claim 1, wherein the learning model information comprises information associated with a tolerance threshold for output data of the AI model or information associated with a distribution of learning input data of the AI model.

4. The method of claim 3, wherein the determining of whether to retrain the AI model comprises determining to retrain the AI model in case that an error between output data included in the inference information and ground truth is greater than or equal to the tolerance threshold.

5. The method of claim 3, wherein the determining of whether to retrain the AI model comprises determining to retrain the AI model in case that an error between input data included in the inference information and learning input data of the AI model is greater than or equal to a preset threshold based on the information associated with the distribution of the learning input data of the AI model.

6. The method of claim 1, wherein the learning model information comprises a normalization factor associated with data for training the AI model.

7. The method of claim 1, wherein the request message for retraining the AI model is a radio resource control (RRC) message.

8. The method of claim 1, further comprising:
receiving, from the BS, a retraining information request message including information associated with a data size for retraining the AI model; and
transmitting, to the BS, a retraining information message including at least one of the data size for retraining the AI model or information associated with a distribution of data for retraining the AI model.

9. The method of claim 8, wherein the retraining of the AI model comprises receiving, from the BS, a message requesting additional data for retraining the AI model based on the information associated with the data size for retraining the AI model and the data size for retraining the AI model.

10. A method performed by a base station (BS), the BS comprising:
transmitting, to a user equipment (UE), learning model information for an artificial intelligence (AI) model;
receiving, from the UE, a request message for retraining the AI model; and
retraining the AI model based on the request message,
wherein inference information is used to determine whether to retrain the AI model, the inference information obtained by using the AI model and the learning model information.

11. The method of claim 10, wherein the learning model information comprises information associated with a data size for training the AI model.

12. The method of claim 10, wherein the learning model information comprises information associated with a tolerance threshold for output data of the AI model or information associated with a distribution of learning input data of the AI model.

13. The method of claim 10, wherein the learning model information comprises a normalization factor associated with data for training the AI model.

14. The method of claim 10, wherein the retraining of the AI model comprises:
transmitting, to the UE, a retraining information request message including information associated with a data size for retraining the AI model; and
receiving, from the UE, a retraining information message including at least one of the data size for retraining the AI model or information associated with a distribution of data for retraining the AI model.

15. The method of claim 14, wherein the retraining of the AI model comprises transmitting, to the UE, a message requesting additional data for retraining the AI model based on the information associated with the data size for retraining the AI model and the data size for retraining the AI model.

16. A user equipment (UE) comprising:
a communicator;
memory storing one or more instructions; and
at least one processor operably coupled to the communicator and the memory, the at least one processor configured to:
receive, from a base station (BS), learning model information for an artificial intelligence (AI),
determine whether to retrain the AI model based on inference information obtained by using the AI model and the learning model information, and
transmit, to the BS, a request message for training the AI model, in case that retraining of the AI model is determined.

17. The UE of claim 16, wherein the learning model information comprises information associated with a tolerance threshold for output data of the AI model or information associated with a distribution of learning input data of the AI model.

18. The UE of claim 17, wherein the at least one processor is further configured to retrain the AI model in case that an error between output data included in the inference information and ground truth is greater than or equal to the tolerance threshold.

19. The UE of claim 17, wherein the at least one processor is further configured to retrain the AI model in case that an error between input data included in the inference information and learning input data of the AI model is greater than or equal to a preset threshold based on the information associated with the distribution of the learning input data of the AI model.

20. The UE of claim 16, wherein the at least one processor is further configured to
receive, from the BS, a retraining information request message including information associated with a data size for retraining the AI model, and
transmit, to the BS, a retraining information message including at least one of the data size for retraining the AI model or information associated with a distribution of data for retraining the AI model.
